(19) United States
(12) Patent Application Publication
(10) Pub. No.: US 2014/0312574 A1
(43) Pub. Date: Oct. 23, 2014

(54) SPACER AND GASKET ASSEMBLY INCLUDING A WET SEAL FOR USE ON AN AIRCRAFT

(71) Applicant: Aviation Devices & Electronic Components, L.L.C., Fort Worth, TX (US)

(72) Inventors: Jeff Busby, Millsap, TX (US); Matt Boyd, Fort Worth, TX (US)

(73) Assignee: Aviation Devices & Electronic Components, L.L.C., Fort Worth, TX (US)

(21) Appl. No.: 14/264,216

(22) Filed: Apr. 29, 2014

Related U.S. Application Data
(63) Continuation-in-part of application No. 13/793,533, filed on Mar. 11, 2013.
(60) Provisional application No. 61/669,957, filed on Jul. 10, 2012.

(51) Int. Cl. F16J 15/10

(52) U.S. Cl. CPC F16J 15/10
USPC 277/637

(57) ABSTRACT

A spacer and gasket assembly is shown for receipt between a static structure having an outer and inner surface and fastener holes therethrough and a removable structure having a base with fastener holes and an upper surface and a lower surface. The static structure and removable structure are engaged through a multiplicity of fasteners having a shaft diameter. The fasteners are adapted to apply a compression on the gasket between the static structure and the removable structure. The static structure and the removable structure have opposed, typically flat, facing walls. The spacer and gasket assembly comprising a substantially non-compressible spacer adapted for receipt between the static structure and the removable structure having a spacer thickness. A gasket has a deformable, flowable, elastomeric body and a skeleton having a skeleton thickness, the skeleton substantially integral with the body. The gasket has an uncompressed gasket thickness. The spacer and the gasket are adapted to be placed substantially between the facing walls of the static structure and the removable structure and the removable structure will compress and deform the gasket when the fasteners are torqued down.

This continuation-in-part application claims priority to, benefit of, and incorporates herein by reference, U.S. patent application Ser. No. 13/793,533, filed Mar. 11, 2013, and U.S. Provisional Application Ser. No. 61/669,957, filed Jul. 10, 2012.

### FIELD OF THE INVENTION

Multi-component aircraft assemblies and, more particularly, to a spacer and gasket assembly for an interposition under compression between a static structure of an aircraft and a removable structure of an aircraft.

### BACKGROUND OF THE INVENTION

The use of gaskets for environmental sealing in aircraft, especially the outside of an aircraft, has some unique challenges. In its lifetime, an aircraft will undergo environmental extremes, pressures ranging from those typically found at sea level to the extremely air pressures found at 40,000-50,000 feet. Temperature ranges are also subject to extremes, as are humidity conditions and pressure differentials across a gasket.

Given such a radical and extreme environment, environmental seals, such as gaskets and gasket assemblies, especially those adapted for use on an aircraft exterior, must often have unique properties. Furthermore, the gaskets sometimes must be adapted to be conductive or nonconductive between the pieces that they join, depending upon their application. Furthermore, potential reactivity with the aircraft structures to which they engage is yet another consideration.

### SUMMARY OF THE INVENTION

In one embodiment, a spacer and gasket assembly for receipt between a static structure having an outer and inner surface and fastener holes therethrough and a removable structure having a base with fastener holes and an upper surface and a lower surface, the static structure and removable structure typically being engaged through a multiplicity of fasteners adapted to apply a compression on the gasket between the static structure and the removable structure, the spacer and gasket assembly. The assembly comprises a substantially non-compressible spacer adapted for receipt between the static structure, and the removable structure having a spacer thickness; and a compressible gasket having a deformable, flowable (under compression) elastomeric body and a crushable skeleton, substantially enclosed with the body. The spacer and the gasket are placed between the static structure and the removable structure and the fasteners torqued to a preselected value.

### BRIEF DESCRIPTION OF THE DRAWINGS

FIG. 1 is an exploded perspective view of Applicants' spacer and gasket assembly as used on an aircraft between a static structure and a removable structure.

FIG. 1A is a perspective view of a washer for use with the present invention.

FIGS. 2 and 3 are cross-sectional views of Applicants' spacer and gasket assembly between a removable structure and a static structure on an aircraft body; FIG. 2 before compression; FIG. 3 after compression.

FIGS. 4 and 5 are alternate preferred embodiments of Applicants' spacer and gasket assembly.

FIGS. 6, 7, and 8 are exploded perspective and side elevation cross-sections of an alternate preferred embodiment of Applicants' spacer and gasket assembly. FIG. 7 before compression; FIG. 8 following compression.

FIGS. 9A, 9B, and 9C illustrate cross-sections of the stacked washer in cross-sectional side view, uncompressed, partially compressed, fully compressed.

FIG. 10 illustrates a cross-sectional view of a procedure for installing any of the embodiments of Applicant's spacer and gasket assembly, wherein a wet seal of uncured polyurethane gel mix is applied on or about the fastener or fastener hole junction prior to installation of the fastener through the workpiece into the static structure.

FIGS. 11A and 11B illustrate in perspective views, a spacer and gasket assembly in which the spacers are embedded in the body of the gasket, such that the assembly is a unitary one-piece assembly.

FIGS. 12A and 12B are top and side views of another embodiment of the spacer and gasket assembly.

FIGS. 13A and 13B are top and side views of another embodiment of the spacer and gasket assembly.

FIG. 14 is a top view of another embodiment of the spacer and gasket assembly.

### DETAILED DESCRIPTION OF THE PREFERRED EMBODIMENTS

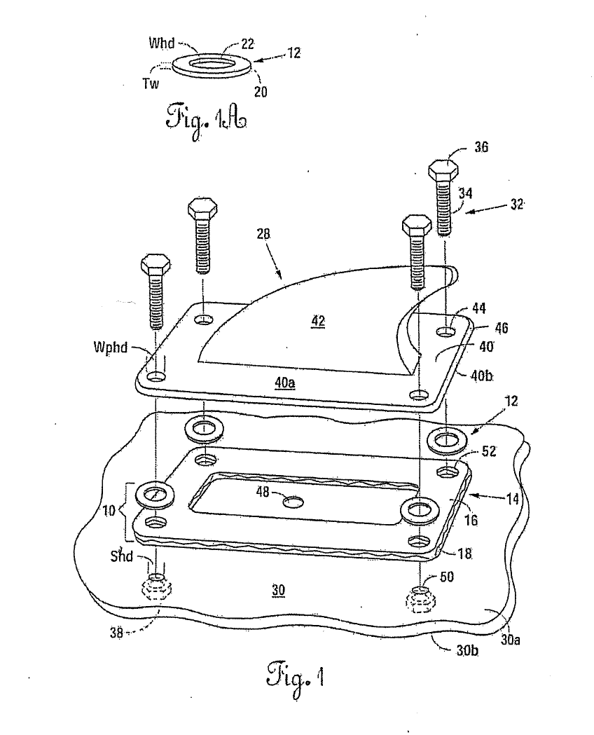

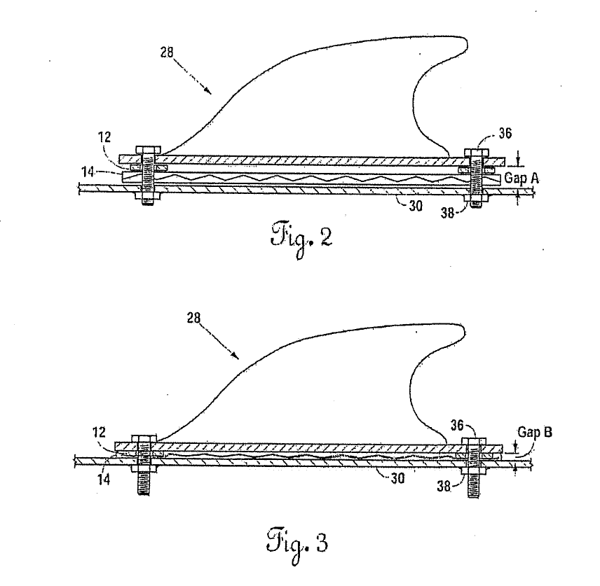

FIGS. 1-5 illustrate an embodiment of Applicants' spacer and gasket assembly 10, seen in an embodiment to include a spacer or other mechanical stop, such as a washer 12, and a gasket 14 for interposition in a stacked arrangement between a removable workpiece 28 and a static structure 30.

A multiplicity of fasteners 32 may be provided for engaging the removable workpiece 28 and static structure 30, the fasteners typically including a shaft 34 with a threaded portion thereon, the shaft having a head 36 at one end, such as a hex head, for engaging a drive tool, such as a torque wrench. Shaft 34 is adapted to engage a nut 38, such as a blind nut or captured nut 38, as illustrated in FIG. 1.

Removable workpiece 28 may, in one embodiment, be an aircraft antenna for removable receipt against a gasket 14 and a washer 12 for attachment to static structure 30 which, in a preferred embodiment, may be the outer fuselage of an aircraft body. Removable workpiece 28 may include a base 40, which may be tabular, with an upper surface 40a and a lower surface 40b. Lower surface 40b may be planer or slightly curved and may conform in shape to outer surface 30a of static structure 30. For example, if outer surface 30a is flat, lower surface 40b may be adapted to conform to the flat outer surface 30a of the static structure and may be flat also. If there is a slight curve to outer surface 30a, lower surface 40b may match the curve of outer surface 30a of the static structure.

Removable workpiece 28 may include an extended member 42, such as the fin of an antenna, the antenna for receipt or transmission of RF or other signals from an aircraft. Removable workpiece 28 may also include a multiplicity of fastener receiving holes 44, the holes with a diameter of Wpd (workpiece diameter). Moreover, the removable workpiece may have an outer perimeter 46.

Static structure 30 may include an access port 48, such as in one embodiment, an access port 48 for electrically conductive cables engaging an antenna electrically to the interior of an aircraft. Outer surface 30a may represent the skin of an aircraft and inner surface 30b may represent the underside thereof. Fastener holes 50 may be provided for receipt of fasteners 32 therethrough, the fastener holes having a diameter of Shd, which is typically equal to diameter Wphd, which is, just slightly larger than the diameter of the shaft that is carried in holes 44/50.

Turning now to gasket 14, gasket 14 may include a body 16 of any suitable compressible and deformable medium, and, in one embodiment, a skeleton 18, the skeleton may be electrically conductive or non-conductive and may be woven or non-woven and, in one embodiment, may be woven fiberglass (i.e., non-conductive) and in another embodiment may be woven aluminum wire (or other suitable electrical conductor, i.e., conductive). A skeleton 18 may be crushable; that is, under some compression, such as about 150-250 psi, may flatten out or otherwise deform. In one specific embodiment, skeleton 18 is a woven fiberglass member.

Typically, a crushable skeleton will be one that will undergo permanent deformation under compression between a workpiece, such as an aircraft antenna and a base, such as the wing or fuselage of an aircraft. In one embodiment, there may be permanent deformation or set, so that when pressure is released, there will be very little rebound of the fibers of the crushed skeleton. In one embodiment, the crushable skeleton is woven. In one embodiment of woven skeletons, the skeleton may be metallic, such as an 18×18 strands per inch woven mesh (17 mil strand diameter), aluminum fabric available from Cleveland Wire Cloth, Cleveland, Ohio. In another embodiment, the crushable skeleton may be a non-metallic fabric, such as a woven fiberglass fabric. One such fabric is available from Phifer, Tuscaloosa, Ala., Part No. 3021975, which provides a woven fiberglass non-metallic screen.

Typically, the body is coherent and integral with the skeleton for those embodiments using a skeleton. Typically, the skeleton is not a solid sheet, but one with many holes or pores. The gasket body material, for example, polyurethane, will flow, uncured, through the pores like many tiny arms and hook up with other arms of elastomer running through the holes, such as to provide, on curing, a coherent, integrated skeleton, elastomeric gasket.

In a preferred embodiment, gasket 14 may be an Avdec product, for example, Part Nos. AG8430000-88, AG723000-28 or AG822000-14. Some of these gasket bodies and skeleton combinations are disclosed in the following Avdec patents incorporated herein by reference: U.S. Pat. Nos. 6,530,577; 6,695,320; and 7,229,516.

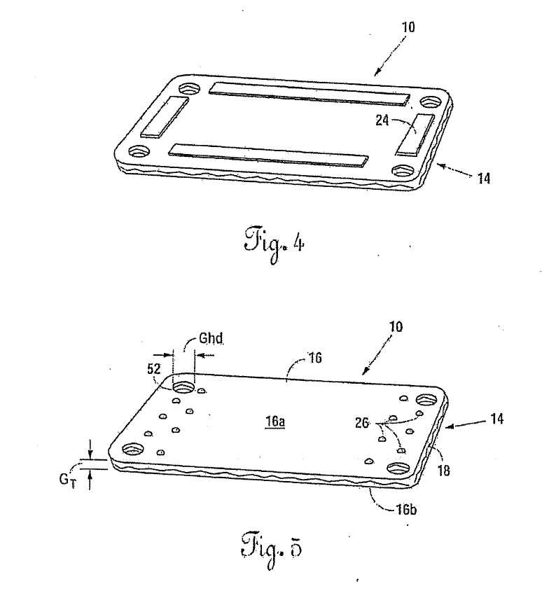

FIGS. 2 and 3 illustrate that the washer 12 may lay stacked in a pre-compression state above the upper surface of the gasket, prior to compression (FIG. 2). Compression is accomplished by rotation of fastener head 36 against non-movable nut 38, which compression may be achieved with a torque wrench to preselected values.

A comparison of FIG. 2 to FIG. 3 will illustrate that under compression, the gasket 14 will deform, with the body at least flowable and deformable by displacement of the spacer thereinto. However, it is also seen that, typically, preselected torque limits will be reached before all of the elastomer between the lower surface of the washer and the base is squeezed out. That is to say, in one embodiment, there is typically a gap between the lower surface of the spacer and the upper surface of the static structure that leaves some elastomer and some skeletal material (typically crushed) therebetween. If the skeletal material is a woven metallic mesh, it typically engages both the underside of the antenna (moveable piece) and outer surface of the aircraft fuselage (static).

One of the uses of Applicants' gasket and spacer assembly is to or substantially eliminate the re-torque requirements when standard elastomeric gaskets, used without spacers, are tightened between a removable workpiece and a static structure. In the prior art, the deformable and flowable nature of the body of the gaskets caused (after an initial torque to a preselected value) a drop in the released torque after a period of time, for example, 15 to 60 minutes. That is to say, prior art gaskets for properly seating the gasket between the removable workpiece and static structure required re-torquing (back up to a preselect value) after a period of time. This is likely due to the set of the elastomeric body, deformation taking place over a period of time under compression, which would require re-torquing of fasteners 32.

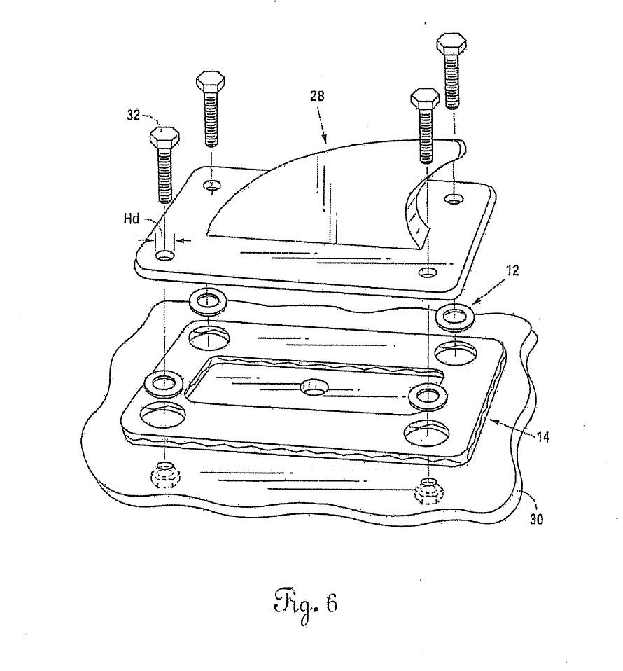

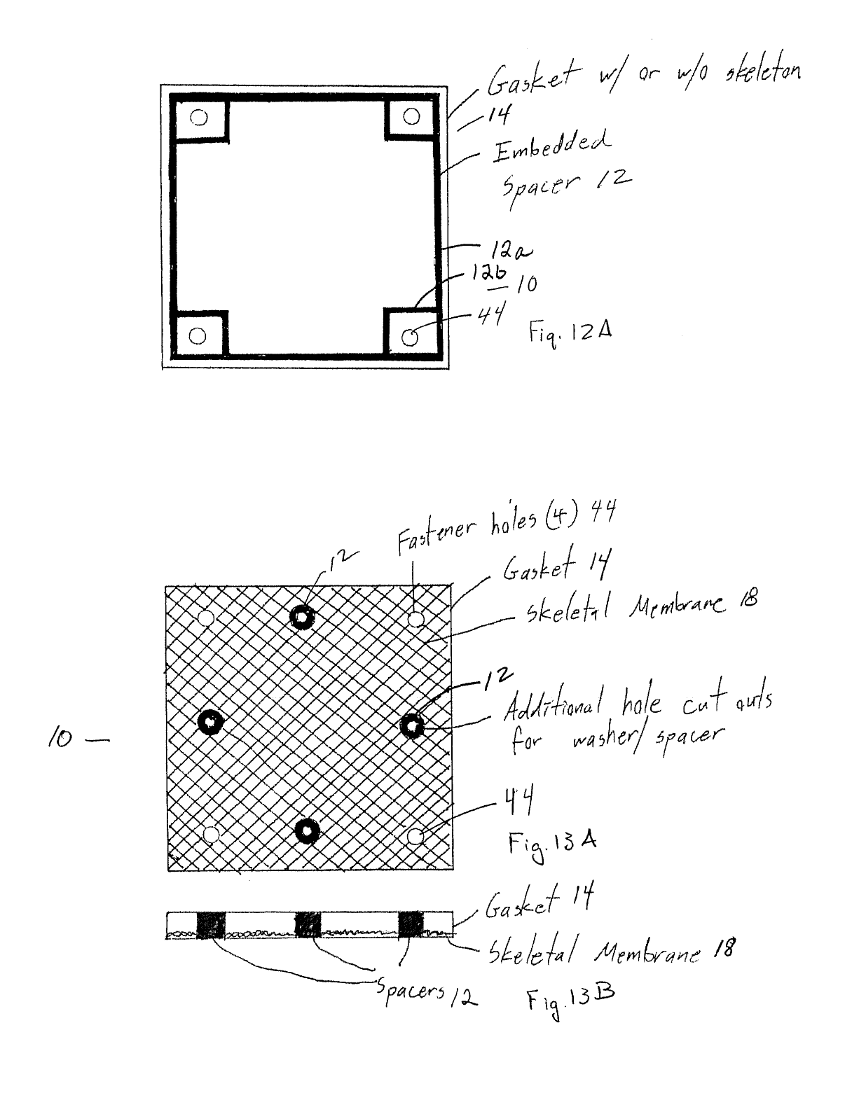

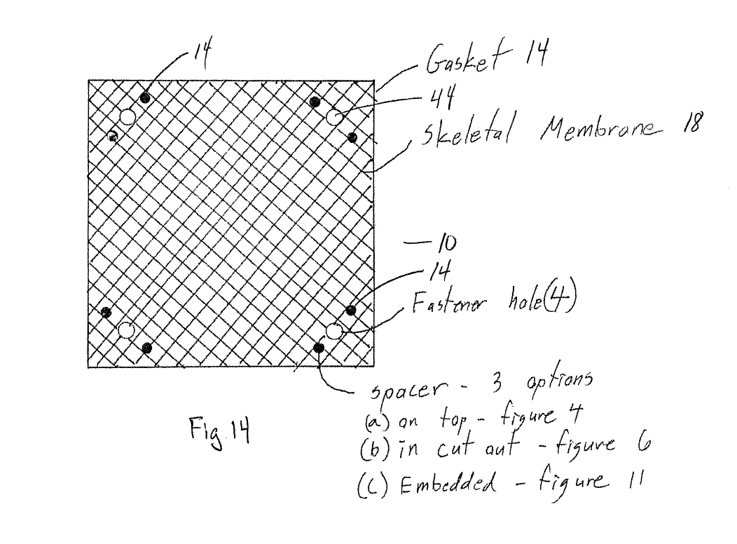

Applicants' use of a novel spacer and gasket assembly provides a substantially incompressible mechanical stop, such as washer or, in the embodiments set forth in FIGS. 4 and 5, plates 24 or spheres 26 (or any suitable configuration), FIGS. 12A and 12B, shaped to body, and FIG. 14 disc or cylinder. In one embodiment, the incompressible members may have flat top and bottom surfaces for generally flush contact with the moveable workpiece and stationary member. On the other hand, the top and bottom surfaces of the incompressible spaces, including conductive metal spaces, may have spikes or pointed projections extending therefrom for good electrical contact between the two pieces. Such substantially non-compressible members, when stacked with relation to the deformable body of the gasket, including, typically, a compressible skeleton, will provide a substantial mechanical block, such that initial torquing of the fasteners to a preselected value will not result in a substantial drop (over time) in such preselected value. Therefore, re-torquing may be eliminated.

In FIGS. 1-3, the mechanical stop or spacer is seen to be configured as a washer, that is, a generally cylindrical body having flat upper and flat lower surfaces, and having a thickness Tw, an outer perimeter 20, and an inner perimeter 22. The diameter of the inner cutout of the washer is designated Whd.

In a preferred embodiment, the spacers are stacked (placed on top of the gasket) (see FIGS. 2 and 3), and spacer thickness Tw may be nominally 0.03″ or in the range of 0.01″ and 0.07″. Gasket thickness may be nominally 0.045″ or in the range of 0.015″ and 0.120″. The hardness of the elastomer body may, in one embodiment, be in the range given in the previous AVDEC patents and the fiberglass skeleton may be woven fiberglass.

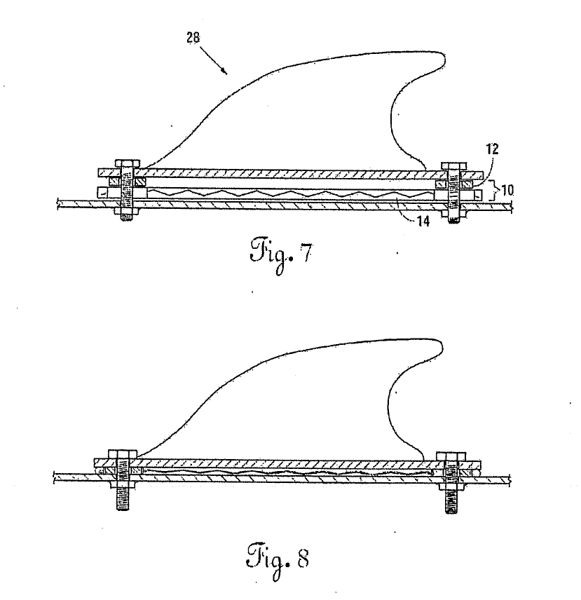

Turning to FIGS. 6 and 7, it may be seen that an alternate preferred embodiment of Applicants' spacer and gasket assembly may be used, wherein the mechanical stops, instead of being stacked on top (or bottom) of the gasket and compressed thereinto, will lay adjacent, in side-by-side fashion, to the gasket, and, in one embodiment, between the lower surface of the antenna and upper surface of the fuselage. The gasket may be typically about 45 mil (range 15 to 80 mil) thicker than the substantially incompressible mechanical stop and deformation of the body will be occasioned during the initial torquing of fasteners 38.

Gap A, FIG. 2, is seen to be typically in the range of about 25 mil to 200 mil; that is, the gap generated by uncompressed stacked spacer and gasket assembly. FIG. 3 illustrates gap B smaller, the washer being compressed into the body of the gasket, which gap may be in the range of 10 mil to 120 mil, which will typically represent sufficient torque on fasteners 38 to be within aircraft specifications and not require re-torque (typical aircraft antenna mounted to aircraft outer surface, metallic or non-metallic skeleton).

FIGS. 2 illustrates a slight cutback or undercut of the outer perimeter of the gasket with respect to the outer perimeter of the workpiece. This indentation is typically sized that, under compression as seen in FIG. 3, the deformation of the elastomer and its subsequent push outward will bring the outer edge of the gasket, when under compression, to about the outer edge of removable workpiece 28. This undercut may be in the range of 50 mil to 250 mil.

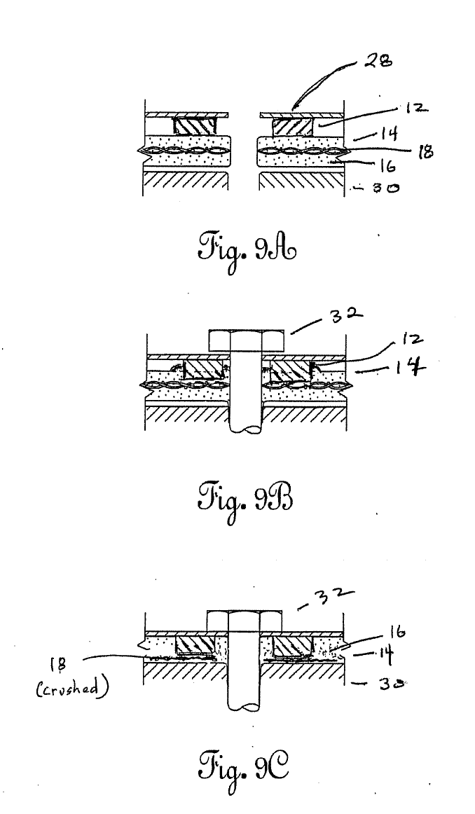

FIGS. 9A, 9B, and 9C illustrate a number of features of embodiments of Applicants' device and assembly. FIG. 9A shows a stacked version uncompressed with the washer laying atop the body of the gasket, the body of the gasket laying on the static member and the top piece being a workpiece , in this case, the antenna of an aircraft. However, under close examination, it may be seen that a hole pre-cut in the gasket for the passage of the fastener therethrough is slightly undercut in one preferred embodiment. The term “undercut” means that the diameter of the hole (typically cylindrical) is equal to or slightly less than the diameter of the shaft of the fastener that is passing through the hole. This will allow some drag on the sticky elastomeric gel as it clings to the shaft of the fastener as the fastener passes through the gasket and into the static structure. This also helps ensure that when the gasket is tightened down and squeeze-out occurs (FIGS. 9B and 9C) that that squeeze-out will be of sufficient volume to fill in and around the gasket holes. It is disadvantageous for too much air to be around the fastener holes. In other embodiments, the fastener hole in the gasket is about equal to or slightly larger (overcut) when compared to the fastener diameter.

In one embodiment, Applicants' various assemblies illustrated and described herein are used on the exterior surfaces of aircraft. As a result, there is a substantial pressure difference between the aircraft exterior and the aircraft interior, for example, when the aircraft is at cruise altitude. That pressure difference is typically great as the aircraft climbs to altitude. Moreover, the pressure differences cycle, as do temperature differences. It may be quite cold at a cruising altitude of 40,000 feet and the air pressure quite low. As a result, one of the objects of Applicants' assembly is to sufficiently fill voids or air pockets which might trap gas and moisture when the aircraft thermal and pressure cycles. It has been found that undercutting the gasket around the fastener holes appears to help achieve these benefits. The undercut may be in the order of magnitude of about 15-100 mil in one embodiment. Also, it has been found that “overcutting” the inner diameter of the washer is also beneficial, the overcutting of the washer refers to the inner diameter of the washer being larger than the fastener shaft passing through. This overcut may be in the magnitude of about 15-100 mil in one embodiment.

In FIGS. 5 and 6, it is seen that hole diameter Hd in the removable workpiece is typically just slightly larger than the shaft 34 of fastener 32, as is known in the art. Ghd is gasket hole diameter and is sufficient to receive the spacer therethrough for the cutout embodiments where the spacer is adjacent to the gasket, rather than sandwiched or stacked.

It is seen in FIGS. 9B and 9C that, as the workpiece is torqued down, the gasket body has sufficient flowability to deform responsive to the washer being pushed into the body. Some of the gasket body material, typically cured polyurethane gel, will be pushed inward and help fill the void left by the gap between the spacer and the fastener and some will be pressed up against the inner facing wall of the workpiece and the outer facing wall of the static structure.

In FIG. 9C, it is seen that, when sufficient torque is placed on the fastener that the lower surface of the washer will contact the upper surface of the skeleton and press it against the upper surface of the workpiece. In the process of torqueing down the fastener, this can actually be felt (rotational force on the fastener increases) and passing this point typically crushes the fibers of the woven or other crushable skeleton against one another to cause skeletal deformation. This typically ensures that a sufficiently tight seal is made from the workpiece to the static structure.

In another embodiment, as illustrated in FIG. 6, the holes or other spaces may be overcut, so that the washer is not pressed into the gel body. In one form of this particular embodiment, a metallic skeleton may be used. In one embodiment of such a configuration, if a metallic skeleton is used, for example, for an EMI application where conductivity is desired between the static piece and the moveable piece, then the washer may be either metallic or non-metallic and is slightly thinner than the precrushed thickness of the metallic skeleton. By sizing the skeleton and washer in such a fashion in the overcut application, it will help ensure that there is some crushing of the metallic skeleton, so as to ensure good contact and conductivity before the hard stop or mechanical stop of the underside of the moveable piece against the washer is achieved.

In one embodiment of the various configurations illustrated herein, the gasket is about 45 mil thick with an encapsulated 13 mil skeleton and a 31 mil nylon washer. Typically, the washer will be driven into the skeleton so as to at least partially crush the skeleton.

The fasteners, in one embodiment, may be typically sized between 0.164 inch to 0.250 inch diameter. The gasket is typically tabular (generally flat top and bottom, thickness much less than width and length) and the area may range, in one embodiment, from 25 square inches to 100 square inches. The number of fasteners between the moveable workpiece and the static base may range, in one embodiment, from 4 to 10. The clamping pressure, in one embodiment, may be 150 to 450 psi (to a crushed skeleton). In another embodiment, the range is 150 to 350 psi (to a crushed skeleton). In one embodiment, nylon washers may be used and the gasket may be slightly undersized, typically, in the range of 1/64 inch to 1/32 inch undersized or undercut, for a tight interference fit.

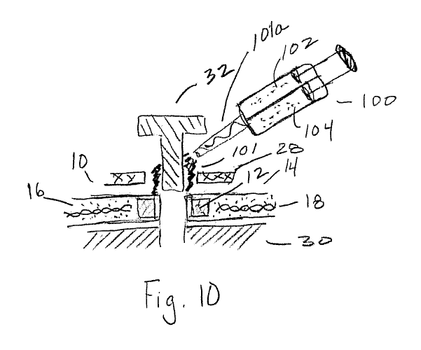

FIG. 10 illustrates the application of an uncured polyurethane 101 on or about the fastener or the gasket or the hole in spacer and gasket assembly 10. FIG. 10 illustrates that uncured polyurethane 101 may be applied with an applicator 100 having a nozzle 101a. Nozzle 101a typically mixes two parts, a polyol 102 and an isocynate 104, which will mix in the nozzle and flow into and adhere in and around fastener 32, the hole in the gasket and will flow at least partway or all the way through the hole in the spacer and gasket assembly and the hole in spacer 12 and typically, at least partially, into the static structure 30. As the polyurethane is uncured in the applied state, it has a consistency somewhat similar to thick motor oil and will stick to, as well as flow about and coat, the space between the fastener and the gasket, the head of the fastener, and the blind nut or a captured nut to which the fastener is attached. In one embodiment, uncured polyurethane mix 101 is applied at the time of placing the removable structure 28 onto the static structure 30, such that the fastener is fastened down before mix 101 cures. The details of mix 101 may be found in the patents incorporated herein by reference. By applying the pre-cured mix to the fastener and the fastener area, as well as the hole, through static structure 30 and spacer and gasket assembly 10, a more complete environmental seal is typically provided.

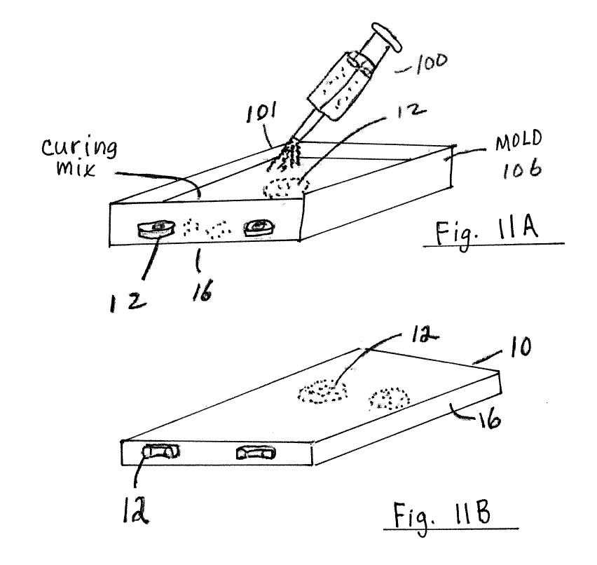

FIGS. 10, 11A, and 11B illustrate that Applicant's spacer and gasket assembly 10 may include spacers 12 that are, during the manufacturing of the gasket, molded into an integral width body 16. Moreover, body 16 may be gel only, such as polyurethane gel, and not have a skeleton at all (see FIG. 11B). For example, FIG. 11A illustrates uncured mix 101 being applied to a mold 106 wherein, prior to curing or before injection of uncured mix 101, the spacers may be placed in the mold. Either way, when the polyurethane mix cures, with or without the skeleton, the entire assembly may be lifted out of the mold and used with an aircraft antenna or other suitable structure. The thickness of the spacer 12 in relationship to body 16 may be such that they are about the same or the spacer is slightly less in thickness, (in one embodiment, 40-80% of the thickness of the body).

FIGS. 12A and 12B illustrate an alternate embodiment of Applicant's spacer and gasket assembly, one in which the spacer 12 is embedded in the gasket body 16 with or without skeleton. In the illustrated embodiment, it is seen that the substantially incompressible spacer (under typical psi ranges found between the static assembly and the moveable workpiece, where one is an aircraft gasket, for example), is an embedded spacer is seen to include members 12a that substantially conform to the outer perimeter of the gasket, such as linear members, that may be along the edge of the gasket or set back, but conform to the shape of the edge. In one embodiment, perimeter conforming set back in the order of magnitude of 20 to 250 mil, for example. FIGS. 12A and 12B also show that, in addition to perimeter conforming members, the spacers may include fastener hole branches 12b that branch off from the perimeter conforming members to substantially surround the fastener holes. These perimeter members may provide support substantially around a fastener, but spaced back somewhat from the spacer hole. In some embodiments, there may be a combination of the linear member spacer illustrated in FIGS. 12A and 12B, and the discrete spaces of the other embodiments. As with the other embodiments, this may be metallic or non-metallic.

In FIG. 12B, it is seen that gasket body 15 may substantially embed spacer 12. The manufacturing process of the spacer illustrated in FIGS. 12A and 12B may be made according to the teachings set forth above, for example, with respect to FIGS. 11A and 11B, wherein the embedded spacers are either laid into an uncured mix before it cures in a mold configured to the required perimeter shape of the gasket or the embedded spacer is laid in first and the uncured mix built up around a mold built to conform to the outer perimeter of the gasket body, or layered in multiple steps, i.e., thin layer of mix is first cured, then spacer laid on top and additional gel added and allowed to cure.

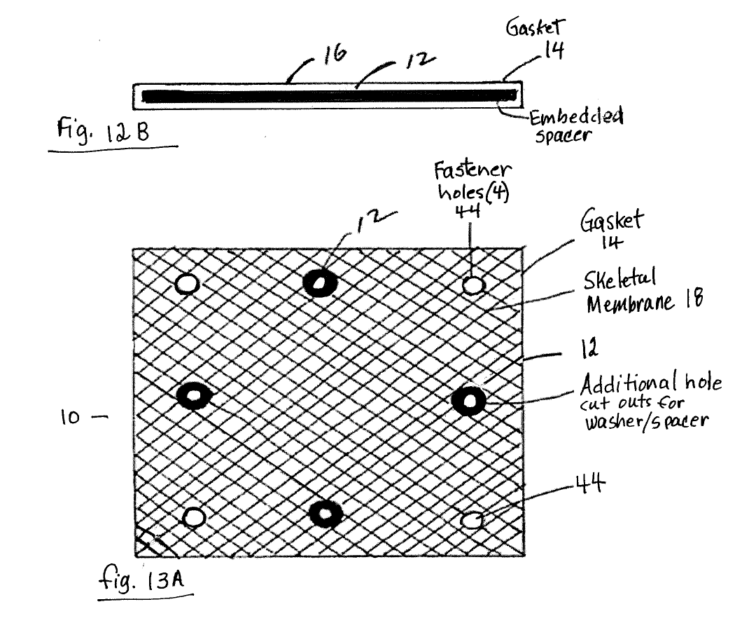

FIGS. 13A, 13B, and 14 show how spacers 12 may be placed in relation to fastener holes 44. As set forth hereinabove, the gasket may be, in one embodiment, such as FIGS. 1, 2, 3 above, the spacers may encircle the fasteners. In other embodiments, they may lay adjacent the fastener holes, for example, in FIGS. 4 and 5, there are spacers 24/26 within about one to three fastener diameters from the fastener to help spread the mechanical stop and minimize flexing of the body of the workpiece. As in all of the previous embodiments of the spacer and gasket assembly, spacers in FIGS. 10-14 may be embedded during manufacturing or may be stacked during assembly or in cutouts shaped to receive the spacers. The spacer cutouts may be made during manufacturing of the fasteners and spacers in ways known in the art, the cutouts for spacers being configured in the same manner as cutouts for fastener holes or other cutouts.

In FIGS. 13A and 13B, it is seen that spacers may be placed about equidistant along a line between adjacent fasteners. These spacers may be configured in any shape set forth herein or in any suitable shape, and may be placed in such positions and used, in one embodiment, with the fastener encircling spacers (here washers) as seen, for example, in FIG. 6, and in another embodiment without the fastener encircling the spacers. FIG. 13B illustrates an embodiment in which a skeletal member, either metallic or non-metallic, and either woven or unwoven, may be disposed closer to or adjacent one of the top or bottom surfaces of the body of the gasket rather than centered.

FIG. 14 illustrates that in one embodiment, the spacer in any shape disclosed herein, disc, circular, tabular, washer, etc., may be placed adjacent on either side of a fastener hole, typically about one or in the range of about 2 to about 5 fastener diameters, to provide a mechanical stop on either side of the fastener hole and adjacent an outer perimeter edge of the gasket. It is seen that each of the fastener holes have the same pair of spacers and, in one embodiment, are configured diagonally, with respect to the corner of the gasket to either side of the fastener hole.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A spacer and gasket assembly for receipt between a static structure having an outer and inner surface and fastener holes therethrough and a removable structure having a base with fastener holes and an upper surface and a lower surface:
a substantially non-compressible spacer adapted for receipt between the static structure and the removable structure having a spacer thickness; and
a gasket having a deformable, flowable, elastomeric body, the gasket having an uncompressed gasket thickness greater than the spacer thickness;
a multiplicity of fasteners having a shaft diameter, the fasteners adapted to apply a compression on the spacer and the gasket between the static structure and the removable structure, the static structure and the removeable structure having opposed, typically flat, facing walls, the spacer and gasket assembly comprising:
wherein spacer and the gasket are adapted to be placed substantially between the facing walls of the static structure and the removable structure; and
wherein a polyurethane gel coats at least part of the some of the multiplicity of fasteners.

2. The spacer and gasket assembly of claim 1, wherein the spacer and the gasket are stacked.

3. The spacer and gasket assembly of claim 1, wherein the spacer and the gasket are side by side.

4. The spacer and gasket assembly of claim 1, wherein the body is comprised of cured polyurethane and is tabular.

5. The spacer and gasket assembly of claim 1, wherein the gasket includes fastener holes which are of a diameter that is about equal to or greater than the shaft diameter of the fasteners.

6. The space and gasket assembly of claim 1 wherein:
the body of the gasket comprises a pliable, resilient, sticky, coherent, homogeneous, silicon-free polyurethane, generally tabular in nature, the body having a generally flat, tacky upper surface, a generally flat, tacky lower surface, an outer perimeter wall,
the spacer has a spacer shape that generally conforms to the shape defined by an outer perimeter wall of the gasket.

7. The spacer and gasket assembly of claim 6, wherein the gasket in an uncompressed state is between about 30 and about 100 mil thick.

8. The spacer and gasket assembly of claim 6, wherein the gasket is between about 20 and 80 mil thick in a compressed state.

9. The spacer and gasket assembly of claim 6, wherein compressed condition of the gasket is about 40-80% of an uncompressed thickness.

10. The spacer and gasket assembly of claim 1, wherein the spacer comprises multiple discrete elements side by side stacked with respect to the gasket.

11. The spacer and gasket assembly of claim 1, side by side with respect to the gasket.

12. The spacer and gasket assembly of claim 1, wherein the spacer includes linear members which conform to a gasket perimeter.

13. The spacer and gasket assembly of claim 12, wherein the gasket includes fastener holes and wherein the spacer further includes linear members which substantially surround at least some of the fastener holes.

14. The spacer and gasket assembly of claim 12, wherein the spacer further includes multiple discrete elements.

15. The spacer and gasket assembly of claim 1, wherein the gasket includes fastener holes and wherein the spacer includes multiple discrete elements proximate the fastener holes of the gasket.

16. The spacer and gasket assembly of claim 15, wherein at least some of the discrete elements lay in the range of about 2 to about 5 fastener diameters from a center of the fastener hole.
The spacer and gasket assembly of claim 1, wherein the gasket includes a non-conductive skeleton.

18. A spacer and gasket assembly for receipt between a static structure having an outer and inner surface and fastener holes therethrough and a removable structure having a base with fastener holes and an upper surface and a lower surface, the static structure and removable structure being engaged through a multiplicity of fasteners having a shaft diameter, the fasteners adapted to apply a compression on the gasket between the static structure and the removable structure, the static structure and the removeable structure having opposed, generally flat, facing walls, the spacer and gasket assembly comprising:
a substantially non-compressible spacer adapted for receipt between the static structure and the removable structure having a spacer thickness; and
a gasket having a deformable, flowable, elastomeric body without a skeleton, the gasket having an uncompressed gasket thickness;
wherein spacer and the gasket are adapted to be placed substantially between the facing walls of the static structure and the removable structure; and
wherein the spacer shape generally conforms to the shape defined by an outer perimeter wall of the gasket wall.

19. A spacer and gasket assembly for receipt between a static structure having an outer and inner surface and fastener holes therethrough and a removable structure having a base with fastener holes and an upper surface and a lower surface, the static structure and removable structure being engaged through a multiplicity of fasteners having a shaft diameter, the fasteners adapted to apply a compression on the gasket between the static structure and the removable structure, the static structure and the removeable structure having opposed, generally flat, facing walls, the spacer and gasket assembly comprising:
a substantially non-compressible spacer adapted for receipt between the static structure and the removable structure having a spacer thickness; and
a gasket having a deformable, flowable, elastomeric body without a skeleton, the gasket having an uncompressed gasket thickness;
wherein spacer and the gasket are adapted to be placed substantially between the facing walls of the static structure and the removable structure.

20. The spacer and gasket assembly of claim 19, wherein the body of the gasket is cured polyurethane.
